(19) United States
(12) Patent Application Publication
(10) Pub. No.: US 2002/0104926 A1
(43) Pub. Date: Aug. 8, 2002

(54) Arrangement for the electrical operation of a door of an aircraft

(76) Inventors: Helmut Marquard, Heist (DE); Adolf Schreger, Pinneberg (DE)

Correspondence Address: REED SMITH LLP, 375 Park Avenue, New York, NY, 10152, US

(21) Appl. No.: 09/895,923

(22) Filed: Jun. 28, 2001

(30) Foreign Application Priority Data
Jun. 29, 2000 (DE) 100 32 851.2

(51) Int. Cl. B64C 1/14

(52) U.S. Cl. 244/129.5

(57) ABSTRACT

An arrangement for the electrical operation of a door of an aircraft, in particular an electrical drive arrangement for the operation of cabin doors of commercial aircraft. The object of finding a new option for operating the doors of aircraft which guarantees an electrical operation of the door with high reliability and a minimum of weight is met by an arrangement for the electrical operation of a door of an aircraft by providing an electrically powered driven shaft for the operation of the door which is coupled to at least one lever arm of the door mechanism so that it rotates together with it and the rotation of which pivots the lever arm of the door mechanism by a predetermined angle. For this, at least two electrical drives independent of each other act on the driven shaft, wherein these drives are both attached to a structural part—relative to which the lever arm of the door mechanism is pivoted—via a coupling mechanism to take up torque opposing the direction of rotation, the coupling mechanism being capable of being uncoupled in direction of the rotation of each drive.

### BACKGROUND OF THE INVENTION

a) Field of the Invention

The invention is directed to an arrangement for the electrical operation of a door of an aircraft, in particular an electrical drive arrangement for the opening and closing and/or the locking and unlocking of cabin door of commercial aircraft.

b) Description of the Related Art

Customarily, cabin doors of commercial aircraft are operated manually, which has the disadvantage that when the commercial aircraft is under great wind load stress or tilted, great physical strength must be exerted which is partially compensated for by a long lever, but this also introduces disadvantages in the areas of kinematics and weight.

Now and again, airplane doors are equipped with an additional electrical drive, mainly to make their operation easier for service personnel. In this case, this electrical drive is added on preferably as a linear drive in adaptation to the door mechanism and the pneumatic linear actuator usually present for supporting emergency operation and for damping the opening movement. Conventional electric drives with their functional sequence of electronics, motor, reducing gear are less reliable and the danger of the line of drive being blocked in particular on the high-speed side of the gear at the juncture with the motor exists. Such a blocking of the power take-off could be undone by means of a coupling on the gear, but this would have to be designed for the great forces occurring in the power take-off and would therefore be impractical for a door drive, especially because of the weight disadvantages.

### OBJECT AND SUMMARY OF THE INVENTION

The primary object of the invention is finding a new option for the operation of doors of aircraft which guarantees an electrical operation of the door together with high reliability and the lowest possible weight.

According to the invention, this object is met for an arrangement for the electrical operation of the door of an aircraft by providing a driven shaft for opening the door that is driven electrically, wherein this driven shaft is rigidly coupled to the arm of a lever of a door mechanism so that they rotate jointly and the lever arm of the door mechanism is pivoted by a pre-determined angle by means of a rotation of the driven shaft. The opening and closing mechanism as well as the locking and unlocking mechanism can be considered for being used as the door mechanism.

Advantageously, at least two electrical drives independent of each other act on the driven shaft and these drives are both attached to a structural part—relative to which the lever arm of the door mechanism is pivoted—via a coupling mechanism to take up torque opposing the direction of rotation, the coupling mechanism being capable of being uncoupled in direction of the rotation of the drive. For this, the drives could be appropriately attached to a structural part of the door, to a movable lever arm (also a structural part) of the door, or to a structural part of the fuselage.

Advantageously, the coupling mechanism is realized as a blockable rotary guide, wherein appropriately removable blocking pins are inserted between the part attached to the structural part and the part attached to the drive housing.

Preferably, the drives fulfill the drive function for the driven shaft at the same time, but it is also advantageous for the drives to alternate in acting in a drive function for the driven shaft, wherein here the passive drive can be switched to a state where no current and (via the coupling mechanism) no force are applied to it so that during normal operation of the door operation operativeness checks of the separate elements of the drives can be done.

It is advantageous for all electrical drives to be capable of being switched to a state where no current and no force are applied to them at the same time, wherein the driven shaft is therefore freed for another way of driving the door operation, in particular by a manual operation.

Suitably, the drives both have a reducing gear and a current controlled motor with control electronics. Preferably, current controlled brushless DC-motors are used as motors.

On the one hand, it is advantageous for each motor to be attached by its housing via a coupling mechanism to the structural part, wherein all other elements of the drive are rigidly attached to the motor. For a particular embodiment of the drives, both motors are connected to the same gear, wherein the gear is rigidly connected to the structural part by its housing and the gear fulfills the function of a type of differential gear. On the other hand and as a suitable alternative, each gear is attached by its housing via the coupling mechanism to the structural part, wherein all other elements of the respective drive are rigidly connected to the gear.

A planetary gear is preferably to be used as the highly reducing gear.

The driven shaft is appropriately arranged parallel to the axes of the drives, wherein each drive has a separate gear pair for the transmission of force onto the driven shaft.

In an advantageous variation, the drives could be dimensioned differently, wherein one drive is provided as a main drive and the other drive is realized as a secondary drive with less power (as an auxiliary drive in case of failure of the main drive), but a reduction of the opening speed would have to be accepted during a failure of the main drive.

In another preferable embodiment form in the invention, the drives acting on the driven shafts are constructionally identical.

In this case, a suitable variation has the driven shaft also arranged parallel to the axes of the drives and being driven by the drives via a shared gear pair for the transmission of force onto the driven shaft (1).

A particularly compact construction is achieved for constructionally identical drives by arranging the driven shaft on the shared axis of the drives, wherein the drives have hollow shafts for this purpose. For the transmission of force onto the driven shaft, a portion of the hollow shafts of the gears with an internal gearwheel could engage in a gearwheel of the driven shaft situated on the inside, but a tongue and groove joint or another type of positive lock connection between the driven hollow shaft of the gears and the driven shaft for the door operation could also exist.

The basic idea behind the invention is based on the thought that the reliability of a completely automatic drive for the electrical operation of aircraft doors is only suitably increased if a blocking of the entire door is excluded by releasing the blocking when the drive failure is recognized and making it possible to still open the door by means of a redundant drive or an emergency opening mechanism.

This is to be provided according to the invention by having two drive units completely or partially independent of each other act on a shared driven shaft, and by switching one drive to a zero force state by removing the drive load moment via a coupling mechanism when necessary or in the case of failure. This coupling mechanism has to take moments similar to a gear coupling on the drive side, but it is a functional component of the housing function and has considerable weight advantages compared with a coupling. The drive units can be chosen to be operated separately or together and permit the discovery of errors during their operating time if they are driven appropriately, for example by alternatingly activating the drives or by monitoring them via sensors. The opportunity for an early reestablishment of a full functional state therefore exists.

The switching to a zero force state of one of the drives relative to the driven shaft is advantageously done in the shape of a coupling mechanism between a drive housing in a rotary bearing and the door structure or the fuselage structure of the aircraft and can be brought about electrically or manually as well as hydraulically or pneumatically.

With the arrangement according to the invention it is possible to guarantee the electrical operation of a door of an aircraft with great reliability and at the lowest expenditure of weight, wherein at least two electrical drives act upon a driven shaft moving levers of the door mechanism and can be switched separately to a zero force state relative to the driven shaft, and wherein in the case of an accident an emergency opening function can be realized with a suitable medium for energy storage or both drives can be separated from the driven shaft for the realization of a manual operation.

Furthermore, the individual drives and their switching to a zero force state can be tested alongside the normal door operating function, and an electrical energy storage medium is easier to check than other energy storage media, so that less service measures for checking the emergency opening function must be taken.

The drive arrangement according to the invention can also be applied to freight doors of aircraft, wherein using electrical drives for opening and closing them (currently mostly done by linear actuators) essentially overcomes the main disadvantage (leaking oil) of hydraulic components and increases the functional safety of the operation of the freight doors by means of the second drive.

The use of the drive arrangement according to the invention is by no means limited to aviation technology, although it has been conceived particularly for this purpose because of the given weight limits and safety standards. Further essential advantages, consisting in the fact that together with increased functional reliability concepts of (electrical) emergency opening can be made possible and the maintenance rate of the door opening mechanism can be decreased, are also of great interest for any other type of automatically operated door.

The invention is subsequently to be explained in more detail.

### BRIEF DESCRIPTION OF THE DRAWINGS

In the drawings:

FIG. 1 shows a schematic diagram of the operating arrangement according to the invention;

FIG. 2 shows a preferred embodiment of the coupling mechanism according to the invention;

FIG. 3 shows a sectional view at right angles to the drive axis of the coupling mechanism in three different states;

FIG. 4 shows an embodiment form of the drive unit with reduced components;

FIG. 5 shows a design form of the invention realized with a hollow shaft; and

FIG. 6 shows an advantageous basic design of the operating arrangement on an existing door opening mechanism of an aircraft.

### DESCRIPTION OF THE PREFERRED EMBODIMENTS

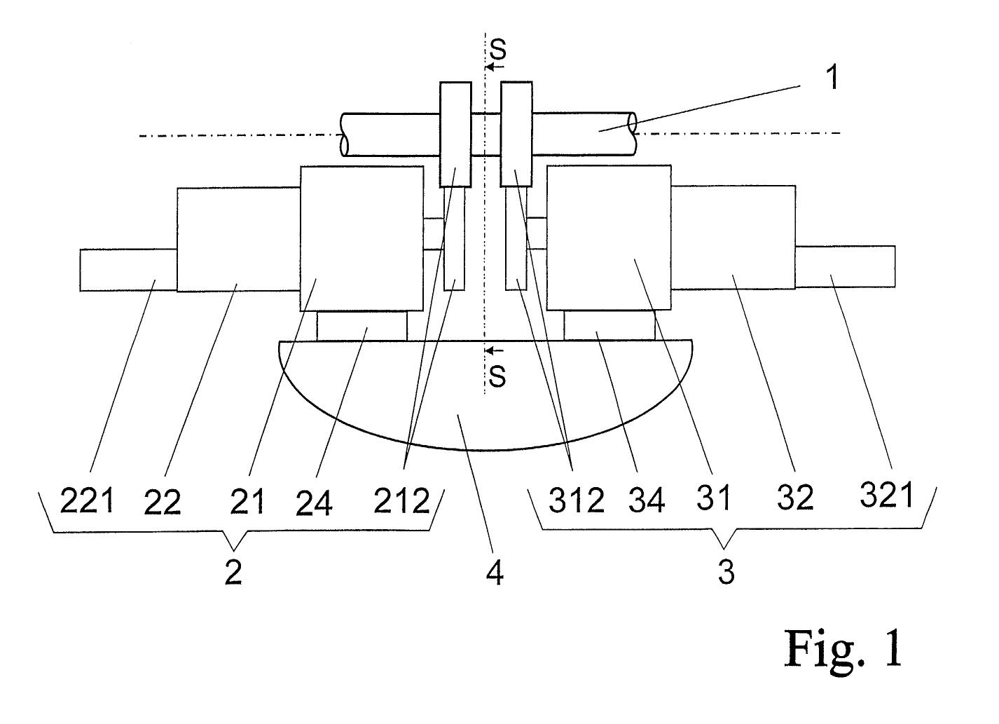

The operating mechanism in its basic structure—as shown in FIG. 1—consists of a driven shaft 1 and two separate drive units 2, 3 of which each has a gear unit 21, 31 and a motor 22, 32 with control electronics 221, 321. The necessary drive load moment of the rotary drive unit 2, 3 is in each case deflected via a coupling mechanism 24, 34 into a structural part 4 of the door or the frame structure.

For the subsequent part, the case of the operation of an aircraft door (opening/closing, locking/unlocking), in particular a cabin door of a commercial aircraft is assumed while a general application is not excluded. The principle according to the invention can be applied to any other automatic door and is not just limited to aircraft of all types, although it has been especially conceived for the latter for the purpose of attaining a minimum weight solution.

FIG. 1 is an advantageous embodiment of the invention for operating the door mechanism of an aircraft by use of which the basic principle of the invention is to be illustrated.

The driven shaft 1 to which at least one lever arm of the door mechanism is coupled rigidly and which for purposes of opening or also locking the door has to be turned only by a certain angle (normally less than 270 degrees) and under a considerable load is driven by two separate motors 22, 32 via two gear pairs 25, 35 and two independent gears 21, 31. The motors 22, 32 are operated by current control and for this driven by two electronics units 23, 33. Because of the large torque and their very good capability of being current controlled, brushless DC-motors are preferably to be used. To increase the output force further, planetary gears are preferably to be provided as the gears 21, 31—this also because of their rotationally symmetrical construction.

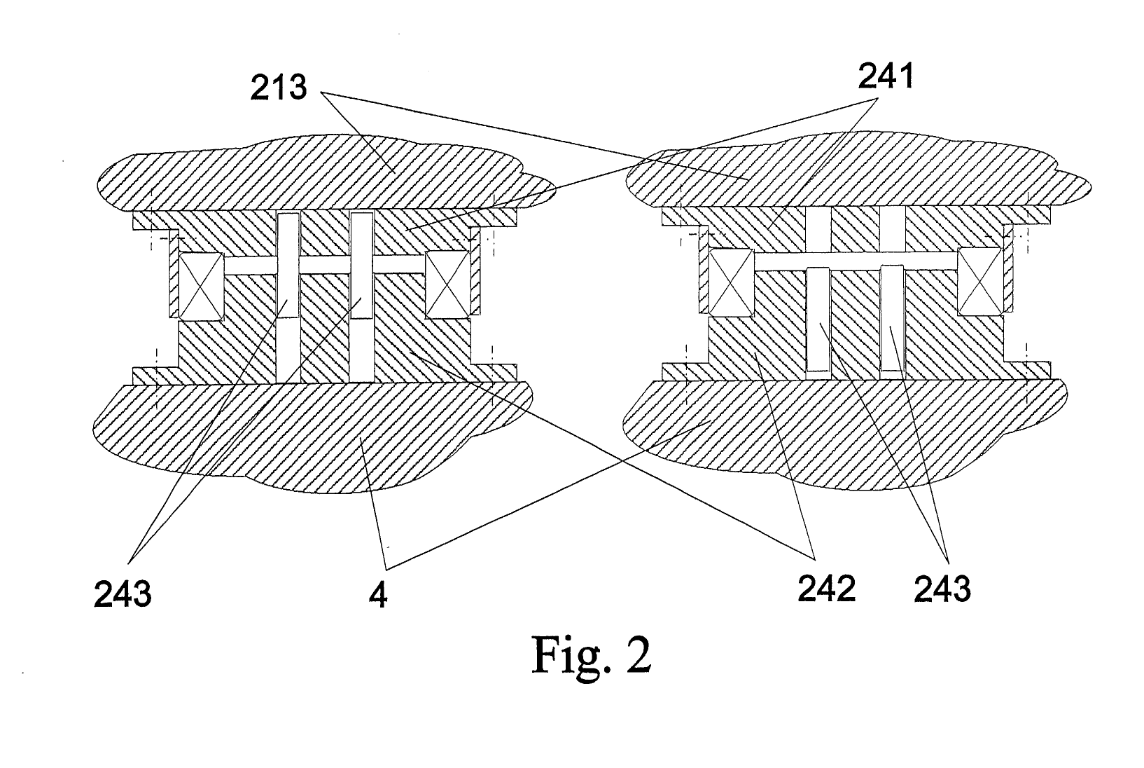

The coupling mechanisms 24, 34 in FIG. 1 are attached to the gears 21, 31 for the purpose of receiving the drive load moments. They are—as shown in FIG. 2 in a longitudinal section through the coupling mechanism 24—realized as a blockable rotary guide, wherein the rotary part 241 which is in a rotary bearing comprises a housing 212 of the entire drive 2 (in FIG. 1 the housings of gear 21 and 31 to which all the other respective elements of the drives 2, 3 are rigidly attached). Between the base part 242 attached to the structural part 4 and the rotary part 241 connected to a drive housing 212, a number of guided blocking pins 243 are inserted. If necessary or in the case of an accident, the blocking pins 243 which turn the rotary guide during normal operations (coupled state) of the drive 2 into a rigid drive holder are removed from the rotary part 241 by pushing them into the base part 242. It is also possible to realize the pin movement by lowering them into the rotary part 241, possibly analogous to the function of the pins of a safety lock.

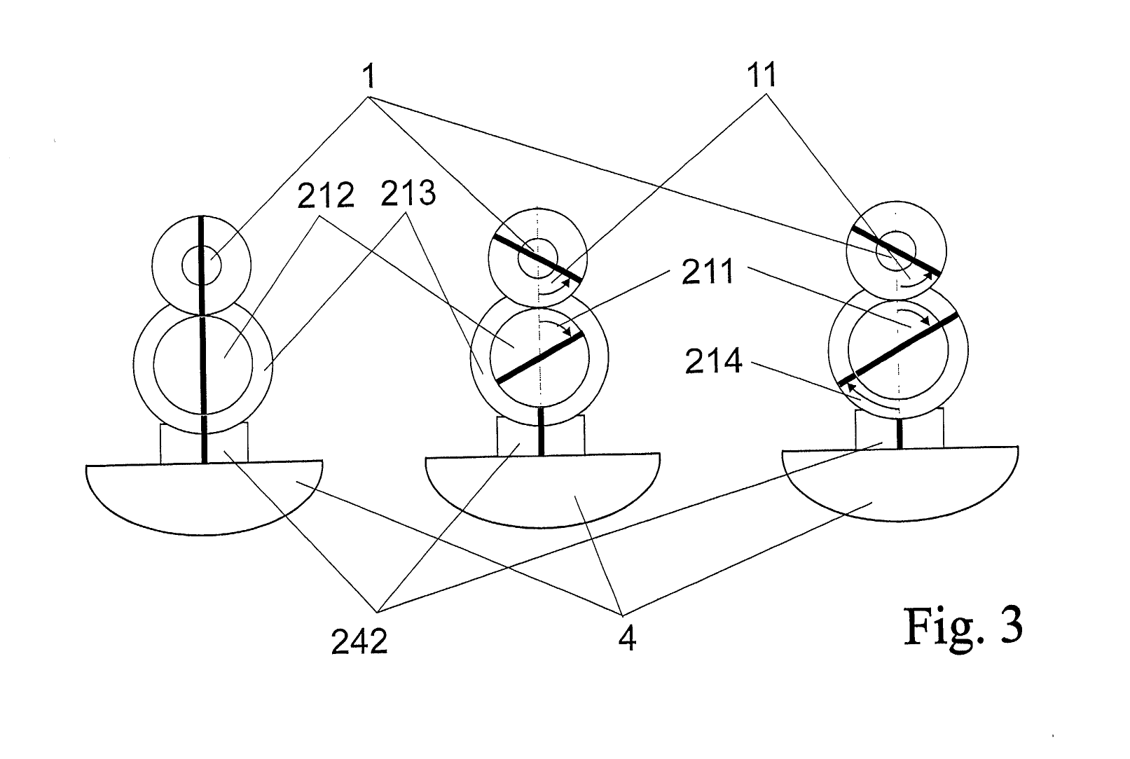

FIG. 3 show the function principle of the coupling mechanism 24, 34 in three different states in a sectional view at right angles to the directions of the axes of the driven shaft 1 and the gear 21.

In the left partial view, the initial state of the left drive 2 (sectional plane S-S) shown in FIG. 1 is represented. To illustrate the principle, all components shown in a sectional view—driven shaft 1, driven gearwheel 212 and housing 213 of the gear 21—are marked with lines which in the initial state all have the same alignment.

The central partial view of FIG. 3 shows the resulting rotational angle 111 of the driven shaft 1 after the motor 22 is activated while the gear 21 acts on the driven gearwheel 212 and the coupling mechanism 24 is coupled, meaning rigid; wherein only the base part 242 of the coupling mechanism 24 is visible, since the rotary part 241 is integrated into the housing 213 of the gear 21. The rotation angle 211 of the driven gearwheel 212 of the gear 21 relative to the base part 242 in this case is zero. In this case, the force is transmitted to the driven shaft 1 via the drive unit 2.

The right partial view in FIG. 3 shows the resulting rotational angle 11 of the driven shaft 1 after the motor 32 (in FIG. 3 the one on the right) is activated. Because of the action of the gear 31 on the driven gearwheel 312 when coupling mechanism 34 is coupled and coupling mechanism 24 is uncoupled, the gear 21 rotates together with its housing 213 in the same direction as the driven gearwheel 212. The rotational angle 214 of the gear housing 213 relative to the coupling mechanism 24 is here maximally equal to the rotational angle 11 of the driven shaft 1. Via the driven shaft 1 the driven gearwheel 212 and the entire drive 2 including the motor 22 rotate along with this by means of internal friction moments (in the case of failure, blocking moments). In this case, no force is transmitted or received by the left drive 2, since the coupling mechanism has been released from the rotation and the drive 2 has therefore been changed to a zero force state.

If necessary, the control of the coupling mechanism 24 or 34 can be done by a number of trigger processes combined in a logic circuit. On the one hand, this is easily done for the current controlled motors 22, 32 by uncoupling the coupling mechanism 34 when a certain current value is exceeded if motor 32 is drawing too much current, or the coupling mechanism 24 is uncoupled if the motor 22 does not remain below the rated current maximum. On the other hand, the uncoupling of the coupling mechanisms 24 or 34 can be triggered by the fact that the corresponding motor 22 or 32 is not rotating in spite of being driven correspondingly, for which purpose a position sensor, for example, a rotation resolver, an encoder or a Hall sensor, is attached. A third possible safety variation provides a door opening sensor which monitors the conversion of the motor drive power into a movement of the door (for example a rotational angle or position sensor on the driven shaft 1) when the motor 22 and/or 32 is triggered. In a fourth variation, both motors 22 and 32 are equipped with different sensor systems, so that each motor is, for example, equipped with a current monitor (threshold) and a rotation sensor, for example, an angle sensor, so that even when, for example, the motor 22 fails, the entire drive 2 is automatically uncoupled via the coupling mechanism 24 and an error message is generated, if necessary.

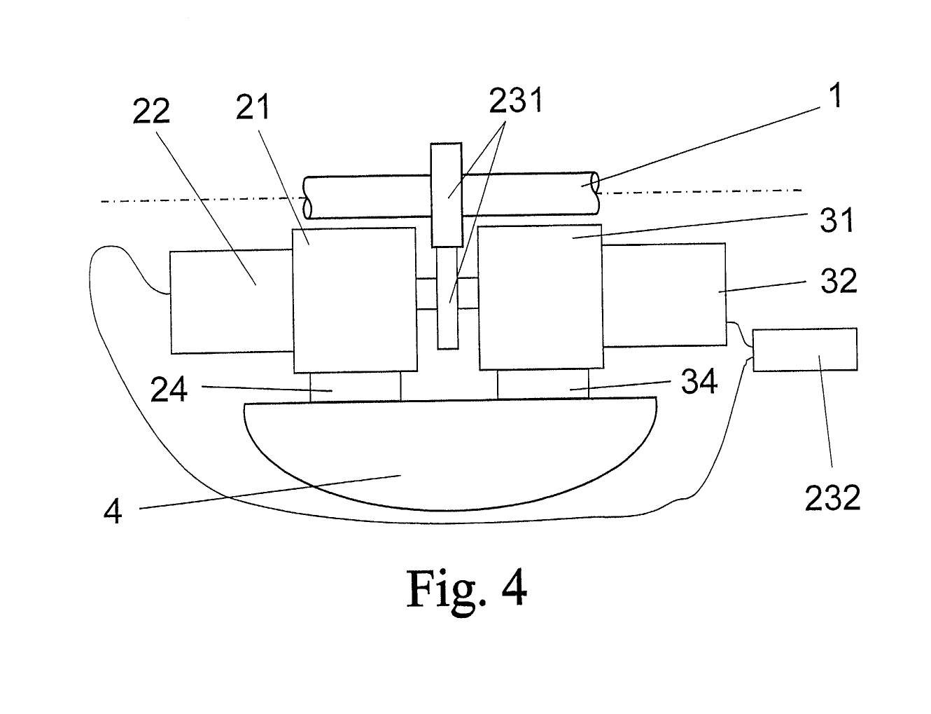

FIG. 4 show an embodiment form of the operating arrangement with reduced components. Here, both gears 21, 31 work on a shared driven gearwheel 231 and the motors 22, 32 are triggered by a shared electronics unit 232. This results in weight savings with only slightly reduced reliability if additional sensors apart from the motor current monitor are there to monitor the rotation of the motors 22, 32.

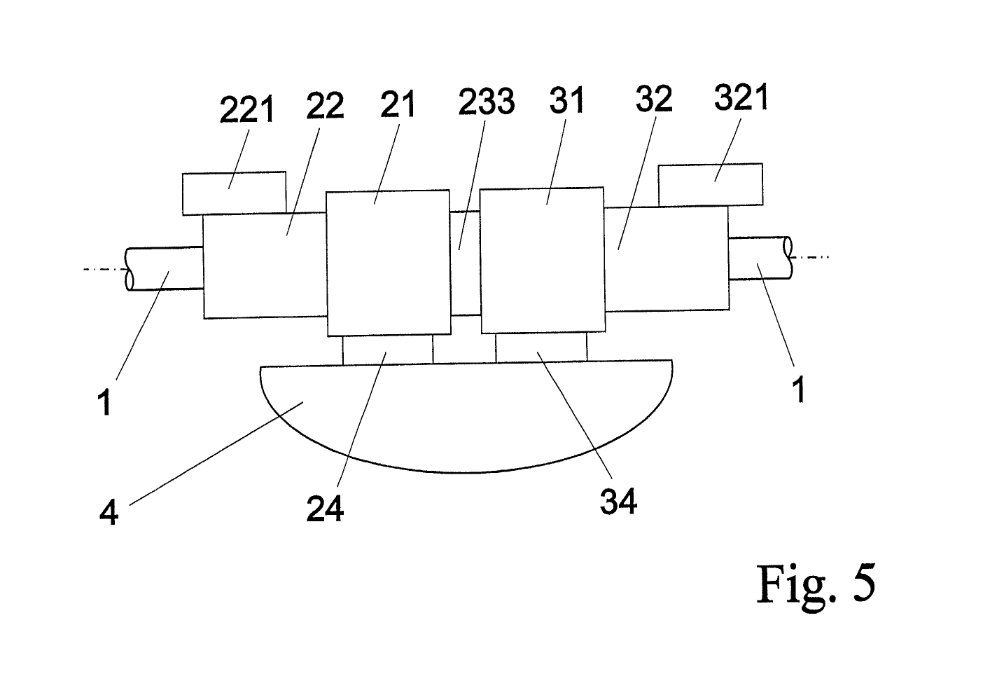

FIG. 5 shows a particularly compact construction of the arrangement according to the invention under use of drive units 2, 3 constructed in a hollow shaft design. Here, the driven gearwheels 212, 312 shown in FIG. 2 are not necessary, since the driven shaft 1 can be connected directly to the outputs of the gears 21, 31 in a positive lock, for example in the shape of a tongue and groove joint. Alternatively, the transmission of force can be realized with an internal gear in the hollow shaft 233 and a gearwheel on the driven shaft 1 meshing with it. The hollow shaft construction results in a further saving of weight for the same reliability but with a more complex construction limiting constructional freedom. On the other hand, play and the need for adjustments of the driven shaft 1 and the hollow shaft 233 are reduced.

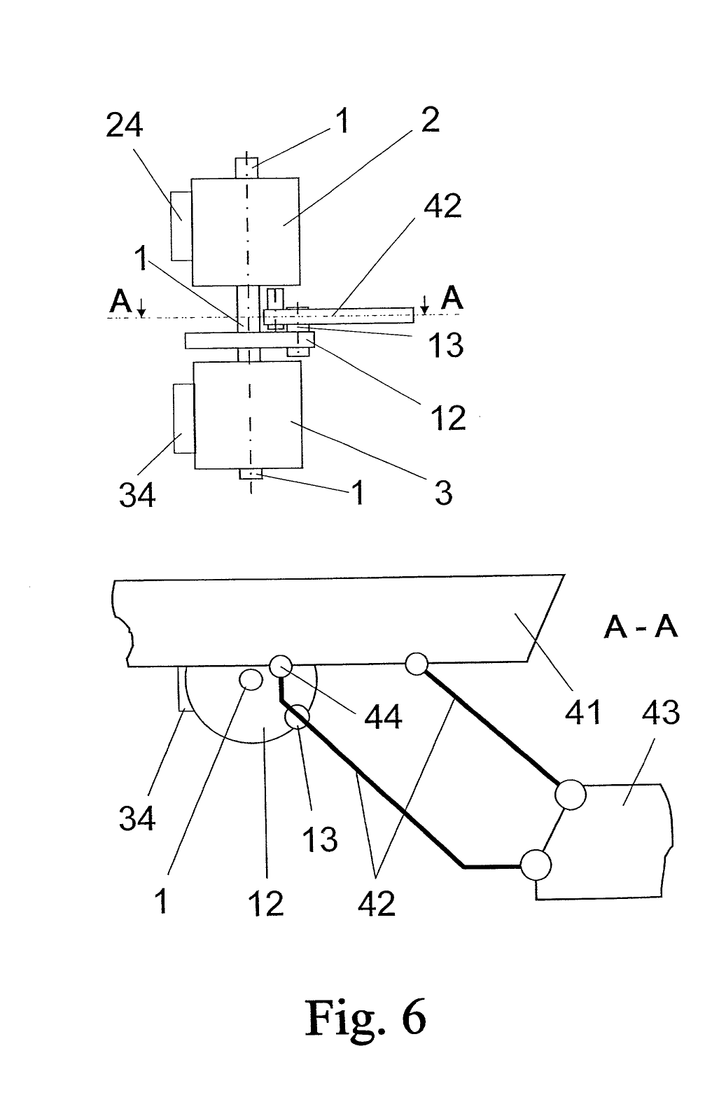

FIG. 6 takes up the embodiment form from FIG. 5 and shows the possible integration of the operating arrangement according to the invention into an existing door opening mechanism. The special way in which the door mechanism functions is only of secondary importance here, since the invention only needs one rotation axis for executing the door movement. Such a rotation axis which for the arrangement according to the invention corresponds to the driven shaft 1 is as such present in all known door systems of commercial aircraft.

The door mechanism shown in a stylized manner in this example is based on the assumption that the door 41 can be lifted out of the fuselage 43 as well as be guided sideways parallel to the outside wall of the fuselage 43 by means of lever arms 42 which function as support and guide arms at the same time and hold and guide the door. Even for this sequence of motions with straight-line motion components, the arrangement according to the invention can be used as a type of rotation actuator. Because of its low weight, the complete operating arrangement is even suitable for being built into a structural part 4 of the door 41, so that even in existing door systems linear actuators that are already present could be replaced simply by changing the door construction.

For the door mechanism chosen for FIG. 6, the door is—according to the view from below—rotated relative to a lever arm 42 (“support arm”) and further lever arms 42 in the sense of a guiding rod system (“guide arms”) with which no drive 2, 3 engages and of which only one is shown in place of all of them take over the forces necessary for guiding the door 41.

The same lever arms 42 can be operated by the operating arrangement according to the invention even if the drives 2, 3 are attached to the structure of the fuselage 43 (not shown). Even attaching them to the lever arm 42 functioning as a “support arm” (or between two such arms situated vertically above each other, also not shown) can by all means be realized.

The top side view shows again the embodiment form of the invention according to FIG. 5 put together as complete hollow shaft drives 2, 3 with a stylized indication of the coupling mechanisms 24 and 34. The driven shaft 1 is embedded in both hollow shafts (not visible) and has for the purposes of force transfer onto the driven lever arm 42 an eccentric disk 5 with guide pins 13 with the rotation of which the lever arm 42 is pivoted on the lever joint 44 and relative to the door 41. Because of the effect of the guiding lever arm 42, which like the driven lever arm 42 is connected to the structure of the fuselage 43 in a manner that permits its rotation, the door 41 is moved essentially laterally to the direction of the driven shaft 1 in a parallel orientation relative to the outside wall of the fuselage—according to the top view in FIG. 6—depending on the direction of rotation of the drives 2, 3.

As it has been emphasized a number of times before, the operating arrangement according to the invention is not limited to aircraft doors with straight-line mechanisms but can also be applied to doors pivoted on a rotation axis by building the driven shaft 1 of the operating arrangement into this rotation axis.

While the foregoing description and drawings represent the present invention, it will be obvious to those skilled in the art that various changes may be made therein without departing from the true spirit and scope of the present invention

LIST OF REFERENCE NUMBERS

| | |
|---|---|
| 1 | Driven shaft 1 |
| 11 | Angle of rotation |
| 12 | Eccentric disk |
| 13 | Guide pin |
| 2, 3 | Drive |
| 211 | Angle of rotation (of the driven gearwheel) |
| 212, 312 | Driven gearwheels |
| 213 | Housing |
| 214 | Angle of rotation (of the gear housing) |
| 21, 31 | Gear |
| 22, 32 | Motor |
| 221, 321 | Control electronics |
| 231 | Shared driven gear pair |
| 232 | Shared electronics unit |
| 233 | Hollow shaft |
| 24, 34 | Coupling mechanism |
| 241 | Rotary part |
| 242 | Base part |
| 243 | Blocking pin |
| 4 | Structural part |
| 41 | Door |
| 42 | Lever arm |
| 43 | Fuselage |
| 44 | Lever joint |

What is claimed is:

1. An arrangement for the electrical operation of a door of an aircraft, comprising:
a driven shaft that is driven electrically being provided for opening the door;
said driven shaft being rigidly coupled to at least one arm of a lever of a door mechanism so that they rotate jointly and its rotation pivots the lever arm of the door mechanism by a pre-determined angle.

2. The arrangement according to claim 1, wherein at least two electrical drives independent of each other act on the driven shaft and wherein the drives are both attached to a structural part via a coupling mechanism to take up torque opposing the direction of rotation, relative to which part the lever arm of the door mechanism is pivoted; wherein the coupling mechanism is capable of being uncoupled in direction of the rotation of the drive.

3. The arrangement according to claim 2, wherein the drives are attached to a structural part of the door.

4. The arrangement according to claim 2, wherein the drives are attached to a movable lever arm of the door.

5. The arrangement according to claim 2, wherein the drives are attached to a structural part of the fuselage.

6. The arrangement according to claim 2, wherein the coupling mechanism is realized as a blockable rotary guide between a structural part and a housing part of the drives.

7. The arrangement according to claim 6, wherein blocking pins which can be removed from at least one part of the coupling mechanism are inserted between the base part attached to the structural part and the rotary part connected to a drive housing and belonging to the coupling mechanism.

8. The arrangement according to claim 2, wherein the drives fulfill a drive function for the driven shaft at the same time.

9. The arrangement according to claim 2, wherein the drives alternate in their drive function for the driven shaft, wherein the passive drive can be switched to a state where no current and, by application of the coupling mechanism, no force apply to it so that during normal door operations checks of the operativeness of the separate elements of the drives can be done.

10. The arrangement according to claim 2, wherein all electrical drives can be switched to a zero force and zero current state, wherein this frees the driven shaft for another drive type for operating the door, in particular for being operated manually.

11. The arrangement according to claim 2, wherein the drives both contain a reducing gear and a current controlled motor with control electronics.

12. The arrangement according to claim 11, wherein the motor is a current controlled brushless DC-motor.

13. The arrangement according to claim 11, wherein the motor is attached by its housing via the coupling mechanism to the structural part and wherein all other elements of the drive are rigidly connected to the motor.

14. The arrangement according to claim 11, wherein both motors are connected to one and the same gear and wherein the gear is rigidly connected to the structural part on the housing side.

15. The arrangement according to claim 11, wherein the gear is attached by its housing via the coupling mechanism to the structural part, wherein all other elements of the drive are rigidly connected to the gear.

16. The arrangement according to claim 11, wherein the gear is a planetary gear.

17. The arrangement according to claim 2, wherein the driven shaft is arranged parallel to the axes of the drives, wherein each drive has a separate gear pair for the transmission of force onto the driven shaft.

18. The arrangement according to claim 17, wherein the drives are dimensioned differently, wherein one drive is provided as a main drive and the other drive is realized as an secondary drive with less power.

19. The arrangement according to claim 17, wherein the drives acting on the driven shaft are constructionally identical.

20. The arrangement according to claim 19, wherein the driven shaft is arranged parallel to the axes of the drives, wherein the drives have a shared gear pair for the transmission of force onto the driven shaft.

21. The arrangement according to claim 19, wherein the driven shaft is arranged inside the shared axis of the drives, wherein the drives have hollow shafts.

22. The arrangement according to claim 21, wherein an internally geared portion of the hollow shafts of the gears meshes with a gearwheel of the driven shaft situated internally.

23. The arrangement according to claim 21, wherein a positive lock connection, is present between the hollow shaft of the gear and the driven shaft for the transmission of force onto the driven shaft.

24. The arrangement of claim 23, wherein the positive lock connection is a tongue and groove connection.
